(19) United States
(12) Patent Application Publication
(10) Pub. No.: US 2006/0162746 A1
(43) Pub. Date: Jul. 27, 2006

(54) Dishwasher and corresponding control method

(76) Inventors: Ayla Kuran, Ankara (TR); Atilla Uz, Ankara (TR)

Correspondence Address: ELLIS & VENABLE, PC, 101 NORTH FIRST AVE., SUITE 1875, PHOENIX, AZ, 85003, US

(21) Appl. No.: 10/540,586

(22) PCT Filed: Dec. 24, 2003
(86) PCT No.: PCT/TR03/00103

§ 371 Date: Jan. 3, 2006

(30) Foreign Application Priority Data
Dec. 25, 2002 (TR) 2002/02716

(51) Int. Cl. B08B 7/04; B08B 9/20; B08B 3/00

(52) U.S. Cl. 134/56 D; 134/58 D; 134/18; 134/25.2

(57) ABSTRACT

This invention relates to a dishwasher (1) comprising a biosensor (7) and a control method which provides an efficient, clean and hygienic washing wherein the main water supply and washing water are microbiologically analyzed in the phases of the program, and the washing water temperature and circulation period are adjusted in each phase.

This invention relates to a dishwasher and a control method which provide an efficient, clean and hygienic washing.

In addition to the cleaning of the washed appliances it is expected to be purified from the germs. Microbiologic pollution is caused by the microorganisms harmful both for the human health and the environment in natural spring waters or main water supply and the reproduction of the bacteria due to the waiting of the kitchen appliances in the dishwasher for cleansing. In the prior art, additive chemicals mixed with the washing and rinsing water and methods such as additional washing cycles and filtration have been used for the elimination of the harmful microorganisms. U.S. Pat. No. 4,147,559 is related to a method in which a precipitation prepared by means of sterilizing chemicals is given by water tub and water feeding units.

U.S. Pat. No. 5,320,118 is related to the solution and dispense of the sterilizing chemicals.

U.S. Pat. No. 4,156,621 discloses a dishwasher in which the additional chemicals are not used for the purification of a reverse osmosis unit.

The object of this invention is to provide a dishwasher and a control method which apply a washing program for microbiologically clean washing and analyze the washing water in certain cycles microbiologically during the program.

In order to achieve the object of this invention the dishwasher and the respective control method are shown with the attached drawings described below.

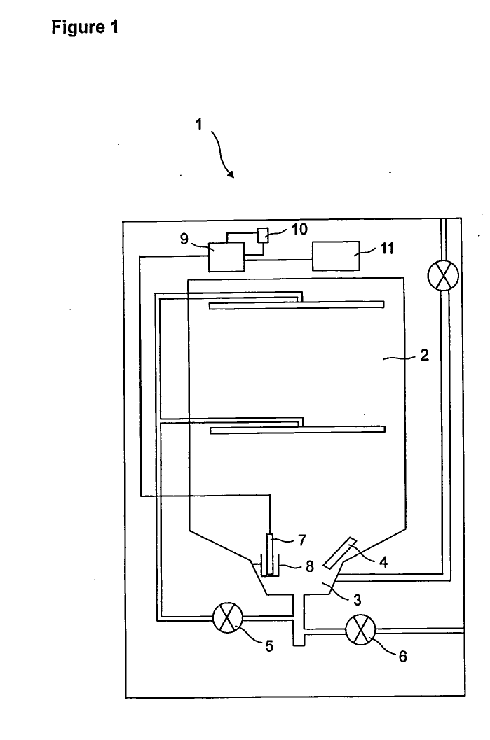

FIG. 1 is a schematic view of a dishwasher.

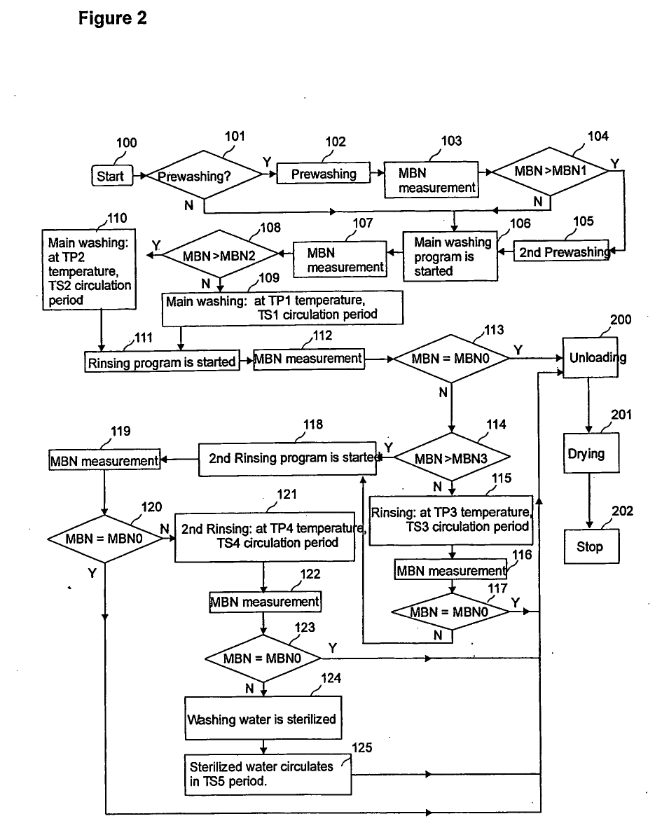

FIG. 2 is a flow diagram of the control method of a dishwasher.

The figures have been each numbered corresponding the following:

1. Dishwasher

2. Washing tub

3. Sump

4. Heater

5. Circulation pump

6. Evacuation pump

7. Biosensor

8. Measurement chamber

9. Microprocessor

10. Memory

11. Control unit

The dishwasher (1) comprises a washing tub (2) where the appliances are put, a sump (3) under the washing tub (2) where the water in the washing tub (2) is collected during the washing process, a heater (4) which is used to heat the washing water, a circulation pump (5) which returns the collected water to the washing tub (2), an evacuation pump (6) which discharges the collected water in the sump (3) as a result of the washing process out of the dishwasher (1), a biosensor (7) which detects the microorganisms in the washing water, a measurement chamber (8) which is suitable for taking as much samples as required for measurement from the sump (3) in every cycles of the washing process, a memory (10) to which the parameters to be compared are loaded, a microprocessor (9) which compares the signals with the parameters loaded to the memory (10) and forwards the result of the comparison and a control unit which enables the biosensor (7) to measure in the required cycles of the washing program and arranges the washing program with respect to the data obtained from the microprocessor (9).

The washing cycle in the dishwashers consists of pre-washing, main washing, rinsing, discharge of the washing water and drying cycles respectively.

The microbiologic pollution rate (MBN) is a variant compared with the limit values measured by the biosensor (7) and loaded to the memory (10) by being predetermined as a result of experimental works by the producer.
MBN1: is the limit value of the acceptable microbiologic pollution rate for the pre-washing cycle.
MBN2: is the limit value of the acceptable microbiologic pollution rate for the main washing cycle.
MBN3: is the limit value of the acceptable microbiologic pollution rate for the rinsing cycle.
MBN0: is the accepted microbiologic pollution rate at the negligible level.

In accordance with the data obtained as a result of the comparison of MBN values measured by the biosensor (7) with preloaded limit values, temperature and circulation period used in the washing cycles have already been loaded to the memory (10) by the producer.
TP1: is the temperature applied in the main washing cycle if MBN<MBN2.
TP2: is the temperature applied in the main washing cycle if MBN>MBN2
TP3: is the temperature applied in the rinsing cycle if MBN<MBN3.
TP4: is the temperature applied in the rinsing cycle if MBN>MBN3
TP1: is the circulation period applied in the main washing cycle if MBN<MBN2.
TS2: is the circulation period applied in the main washing cycle if MBN>MBN2.
TS3: is the circulation period applied in the rinsing cycle if MBN>MBN0 and MBN<MBN3.
TS4: is the circulation period applied in the second rinsing cycle if MBN>MBN0 and MBN>MBN3.
TS5: is the circulation period applied by the sterilized water.

The microbiologic pollution rate (MBN) is measured by the biosensor (7) in at least one of washing program cycles such as the pre-washing, main washing and rinsing cycles. MBN is compared with the limit values and accordingly if MBN is higher than the limit values, temperature and/or period and/or repetition number are changed to reduce MBN below the limit values. On the other hand, if MBN is lower than the limit values, the washing period is continued under the predetermined conditions.

In case microbiologic pollution rate (MBN) can not be lowered to the required level by the changes in temperature and/or period, the washing water is sterilized.

In case microbiologic pollution rate (MBN) can not be lowered to the required level by the changes in temperature and/or period, the washing water is changed and the washing cycle is repeated.

A dishwasher (1) comprising a biosensor (7) is controlled as follows:
The user starts the washing cycle (100),
The user selects either the pre-washing or without pre-washing program (101),
If the without pre-washing program is selected, main washing cycle is started (106),
If the pre-washing program is selected, then the pre-washing program is started (102),
Microbiologic pollution rate (MBN) is measured by the biosensor (7) (103),
MBN is compared with the limit value of the acceptable microbiologic pollution rate (MBN1) for the pre-washing (104),
If MBN<MBN1, main washing cycle (106) is started (106),
If MBN>MBN1, a second pre-washing cycle is started (105),
Main washing cycle is started (106),
Microbiologic pollution rate (MBN) is measured by the biosensor (7) (107),
MBN is compared with the limit value of the acceptable microbiologic pollution rate (MBN2) for the main washing (108),
If MBN<MBN2, main washing cycle is started in TP1 temperature value and TS1 circulation period (109),
If MBN>MBN2, main washing cycle is started in TP2 temperature value and TS2 circulation period (110),
Rinsing cycle is started following the main washing (111),
Microbiologic pollution rate (MBN) is measured by the biosensor (7) (112),
It is checked whether the microbiologic pollution has reached the inefficient level or not (113),
If MBN=MBN0, the rising water is discharged (200),
If the microbiologic pollution is detected (MBN>MBN0), MBN is compared with the limit values (MBN3) of the acceptable microbiologic pollution rate for the rinsing cycle (114),
If MBN>MBN3, second rinsing cycle is started (118),
If MBN<MBN3, rinsing cycle is started in TP3 temperature value and TS3 circulation period (115),
Microbiologic pollution rate (MBN) is measured by the biosensor (7) (116),
It is checked whether the microbiologic pollution has reached the inefficient level or not (117),
If MBN=MBN0, the rinsing water is started to be discharged (200),
If MBN>MBN0, second rinsing cycle is started (118),
Microbiologic pollution rate (MBN) is measured by the biosensor (7) (119),
It is checked whether the microbiologic pollution has reached the inefficient level or not (120),
If MBN=MBN0, the rinsing water is started to be discharged (200),
If MBN>MBN0, second rinsing cycle is started at TP4 temperature value and TS4 circulation period (121),
Microbiologic pollution rate (MBN) is measured by the biosensor (7) (122),
It is checked whether the microbiologic pollution has reached the inefficient level or not (123),
If MBN=MBN0, the rinsing water is started to be discharged (200),
If MBN>MBN0, the washing water is sterilized (124),
Sterilized water is used for rinsing during TS5 circulation period (125),
The rinsing water is discharged (200),
The drying cycle is started (201),
The cycle is ended (202).

A clean and hygienic washing efficiency is achieved by detecting the microbiologic pollution of the washing environment following the test of the main supply water and the circulating washing water means of a biosensor (7) and adjusting the temperature and the circulation period of the washing water in each cycle accordingly.

In order to sterilize the washing water preferably by UV (Ultraviolet) technique in the dishwasher (1) of the so-called invention, water in the sump (3) is subjected to the beams having germicide wavelength by transferring into a tube comprising an ultraviolet lamp via a circulation pump and the sterilized water is returned to the washing chamber.

In another embodiment of the invention, the TV lamps (Ultraviolet) placed in a suitable way in the washing tub (2) provides the elimination of the germs by affecting the materials in the drying machine (1) joining the cycle in the drying cycle following the washing cycle.

1. A dishwasher (1) comprising a washing tub (2) where the appliances are put, a sump (3) under the washing tub (2) where the water in the washing tub (2) is collected during the washing process, a memory (10) to which the parameters to be compared are loaded, a microprocessor (9) which compares the signals with the parameters loaded to the memory (10) and forwards the result of the comparison and a control unit (11) which arranges the washing program with respect to the data obtained from the microprocessor (9) characterized with a biosensor (7) which detects the microorganisms in the washing water.

2. A dishwasher (1) as in claim 1 characterized in that the biosensor (7) is placed in a measurement chamber (8) which is suitable for taking as much samples as required for measurement from the sump (3) in every cycle of the washing process.

3. A dishwasher (1) as in claim 1 characterized with a memory (10) comprising the acceptable maximum microbiologic pollution rates (MBN0, MBN1, MBN2, MBN3) preloaded by the producer in that the microbiologic pollution rate (MBN) measured by the biosensor (7) in the washing cycles is compared.

4. A dishwasher (1) as in claim 1 and 3 characterized with a memory (10) comprising the temperature values (TP1, TP2, TP3; TP4) which are preloaded by the producer and applied in the washing cycles with respect to the results of the comparison with the limit values of the microbiologic pollution rate (MBN) measured by the biosensor (7) in the washing cycle.

5. A dishwasher (1) as in claim 1 and 3 characterized with a memory (10) comprising the circulation periods (TS1, TS2, TS3, TS4) which are preloaded by the producer and applied in the washing cycles with respect to the results of the comparison with the limit values of the microbiologic pollution rate (MBN) measured by the biosensor (7) in the washing cycle.

6. A control method for a dishwasher (1) as in any of the claims above comprising the steps of the measurement of the microbiologic pollution rates (MBN) by the biosensor (7) in at least one of the washing cycles such as pre-washing, main washing and rinsing; the comparison of MBN with the limit values; accordingly the change of temperature and/or period and/or repetition number to reduce MBN below the limit values if measured MBN is higher than the limit values and the continuation of the washing period under the predetermined conditions if MBN is lower than the limit values.

7. A control method for a dishwasher (1) as in claim 6 characterized in that the washing water is sterilized if the microbiologic pollution rate (MBN) can not be lowered to the required level by the changes in temperature and/or period.

8. A control method for a dishwasher (1) as in claim 6 or 7 characterized in that the washing water is changed and the washing cycle is repeated, if the microbiologic pollution rate (MBN) can not be lowered to the required level by the changes in temperature and/or period.

9. A control method for a dishwasher (1) as any of the claims above comprising the steps below
The user starts the washing cycle (100),
The user selects either the pre-washing or without pre-washing program (101),
If the without pre-washing program is selected, main washing cycle is started (106),
If the pre-washing program is selected, then the pre-washing program is started (102),
Microbiologic pollution rate (MBN) is measured by the biosensor (7) (103),
MBN is compared with the limit value of the acceptable microbiologic pollution rate (MBN1) for the pre-washing (104),
If MBN<MBN1, main washing cycle (106) is started (106),
If MBN>MBN1, a second pre-washing cycle is started (105),
Main washing cycle is started (106),
Microbiologic pollution rate (MBN) is measured by the biosensor (7) (107),
MBN is compared with the limit value of the acceptable microbiologic pollution rate (MBN2) for the main washing (108),
If MBN<MBN2, main washing cycle is started in TP1 temperature value and TS1 circulation period (109),
If MBN>MBN2, main washing cycle is started in TP2 temperature value and TS2 circulation period (110),
Rinsing cycle is started following the main washing (111),
Microbiologic pollution rate (MBN) is measured by the biosensor (7) (112),
It is checked whether the microbiologic pollution has reached the inefficient level or not (113),
If MBN=MBN0, the rinsing water is discharged (200),
If the microbiologic pollution is detected (MBN>MBN0), MBN is compared with the limit values (MBN3) of the acceptable microbiologic pollution rate for the rinsing cycle (114),
If MBN>MBN3, second rinsing cycle is started (118),
If MBN<MBN3, rinsing cycle is started in TP3 temperature value and TS3 circulation period (115),
Microbiologic pollution rate (MBN) is measured by the biosensor (7) (116),
It is checked whether the microbiologic pollution has reached the inefficient level or not (117),
If MBN=MBN0, the rinsing water is started to be discharged (200),
If MBN>NBN0, second rinsing cycle is started (118),
Microbiologic pollution rate (MBN) is measured by the biosensor (7) (119),
It is checked whether the microbiologic pollution has reached the inefficient level or not (120),
If MBN=MBN0, the ting water is started to be discharged (200),
If MBN>MBN0, second rinsing cycle is started at TP4 temperature value and TS4 circulation period (121),
Microbiologic pollution rate (MBN) is measured by the biosensor (7) (122),
It is checked whether the microbiologic pollution has reached the inefficient level or not (123),
If MBN>MBN0, the rinsing water is started to be discharged (200),
If MBN>MBN0, the washing water is sterilized (124),
Sterilized water is used for rinsing during TS5 circulation period (125),
The rinsing water is discharged (200),
The drying cycle is started (201),
The cycle is ended (202).

10. A control method for a dishwasher (1) as in claim 9 wherein the washing water is sterilized by UV (Ultraviolet) technique in the sterilization cycle (124) of the washing water if MBN>MBN0.
